(19) United States
(12) Patent Application Publication
(10) Pub. No.: US 2006/0170141 A1
(43) Pub. Date: Aug. 3, 2006

(54) Bellows with fastening mechanism

(76) Inventor: Joachim Wette, Hennef (DE)

Correspondence Address: ARTZ & ARTZ, P.C., 28333 TELEGRAPH RD., SUITE 250, SOUTHFIELD, MI, 48034, US

(21) Appl. No.: 11/323,394

(22) Filed: Dec. 30, 2005

Related U.S. Application Data
(63) Continuation of application No. PCT/EP04/14580, filed on Dec. 22, 2004.

(51) Int. Cl. F16F 5/00

(52) U.S. Cl. 267/122

(57) ABSTRACT

A bellows for a linkage component, having a bellows region, a shaft collar region, a linkage collar region, and at least one strap-shaped and/or annular fastening mechanism, which attaches a collar region of the bellows to a linkage casing or shaft. The fastening mechanism is integrally joined to the collar region, for which purpose, during manufacture of the bellows, the fastening mechanism is inserted into a processing die and at least partially enclosed by plastic material. The side of the fastening mechanism oriented away from the collar region is designed for the engagement of a fastening tool.

### CROSS REFERENCE TO RELATED APPLICATION

This application is a continuation of and claims the benefit of PCT Application No. EP2004/014580 filed on Dec. 22, 2004 entitled “Bellows With Fastening Means”.

### TECHNICAL FIELD

The present invention relates to a bellows for a linkage component, having a bellows region in a shaft collar region and in a linkage collar region, and having at least one fastening mechanism. The present invention also relates to a method for manufacturing a bellows of this kind.

### BACKGROUND

Bellows function as flexible and/or elastic accordion-like covers for linkage components and drive shafts. In particular, bellows are used to prevent dirt from getting into the linkage component, and to also prevent lubricants from escaping out of the linkage component. To that end, bellows are fastened to the shaft end and to the linkage end by means of fasteners known from the prior art, such as clamping elements and compression rings. This entails a relatively high installation cost and gives rise to the desire to simplify installation.

DE 199 56 591 C1 discloses a hose connection in the form of a shaped hose or bellows, with a hose clamp at both hose ends for a clamped attachment of the hose ends to tubular fittings, shafts, or similar cylindrical components. The hose clamp is vulcanized into the component, and annular shoulders made of a plastic material are provided to guide a tool used to compress the annular clamp. This hose connection is protected from corrosion and, particularly when embodied in the form of a bellows, permits a simplified installation onto a linkage component and/or a shaft. In the subject of DE 199 56 591 C1, however, it is disadvantageous that the tool used to close and/or tighten the hose clamp initially comes into contact with a plastic layer in the vicinity of the vulcanized-in hose clamp. The exertion of pressure by the closing tool can cause the plastic material to begin to flow so that the closing tool ends up distributing the closing forces unevenly over the vulcanized-in hose clamp because of the locally varying pressure peaks that can be caused by the flow of a plastic material. Finally, with the subject disclosed in DE 199 56 591 C1, it is disadvantageously necessary to accept an impaired sealing action particularly when it is embodied in the form of a bellows.

### SUMMARY OF THE INVENTION

The present invention provides a bellows and a method for manufacturing a bellows in which the bellows is easier to install, and does not have the disadvantages known from the prior art.

According to one aspect of the present invention, a bellows for a linkage component is created, having a bellows region in a shaft collar region and in a linkage collar region, and having at least one essentially strap-shaped and/or annular fastening mechanism, which attaches a collar region of the bellows to a linkage casing or shaft. The fastening mechanism is integrally joined to the collar region. This is accomplished during manufacture of the bellows wherein the fastening mechanism is inserted into a processing die and at least partially enclosed by plastic material. In addition, the side of the fastening mechanism oriented away from the collar region is designed for the engagement of a fastening tool. The side of the fastening mechanism oriented away from the collar region can comprise a metallic material. This makes it possible for a fastening tool to engage the fastening mechanism in a reliable fashion. It is, however, also possible for the fastening mechanism to be entirely made of a plastic material or to comprise a plastic material only on the side oriented away from the collar region.

An advantage of the bellows according to the present invention lies in the fact that it is easy to manufacture since, particularly in the collar region of the bellows, it is not necessary to provide complex holding fixtures, positioning elements, or the like and the bellows can therefore be simpler in design. The correspondingly embodied positioning, holding, or fixing elements in the collar region are a constant source of trouble since the tightening of the fastening mechanism, which is advantageously embodied as a clamping strap but can also be a clamp or a compression ring known from the prior art, causes the plastic material used for the collar region to begin to flow, depending on the plastic material used, and as a result, sealing problems can arise. In particular, varying pressure peaks occur, which is another disadvantage of the relatively complex collar elements known from the prior art. In a particularly advantageous manner, with the bellows according to present invention, the fastening tool can engage the fastening element directly so that it is possible to avoid a flowing of the plastic material, which can still be present between the fastening element and the fastening tool. It is also possible to assure an even, reliable closing of the fastening mechanism.

The present invention also includes a method for manufacturing a bellows. Specifically, in the region of the first fixing point of a processing die, a fastening mechanism is situated so that at least part of its outside rests directly against the first fixing point, and the bellows is then formed out of a plastic material. The fastening mechanism comes into contact with the plastic material and is at least partially enclosed by it. This makes it possible for the embodiment in which the fastening mechanism is integrally joined to the bellows in the form of a preassembled system to be achieved in an extremely simple manner. The shrinkage of the plastic material after it is removed from the processing die can, provided that no primer is used, lend the fastening mechanism a certain amount of play. The fastening mechanism is nevertheless held securely in the collar region. Primer or similar adhesion-promoting materials can be used to achieve a secure, long lasting, and substantially non-detachable connection between the fastening mechanism and the collar region of the bellows. In the context mentioned above, the phrase “outside of the fastening mechanism” is understood to mean with reference to the finished bellows and may have a plastic coating in some areas so that a fastening tool or closing tool can securely engage the fastening mechanism and exert an even pressure in order to close the fastening mechanism.

Other advantages and features of the invention will become apparent to one of skill in the art upon reading the following detailed description with reference to the drawings illustrating features of the invention by way of example.

### BRIEF DESCRIPTION OF THE DRAWINGS

For a more complete understanding of this invention, reference should now be made to the embodiments illustrated in greater detail in the accompanying drawings and described below by way of examples of the invention.

In the drawings:

FIG. 1 is a partial section through a linkage component in a first embodiment in the form of a bellows.

FIG. 2 is a partial section through a linkage component in a second embodiment in the form of a bellows.

FIG. 3 is a partial section through a pressblower injection blow molding device for manufacturing a bellows according to the invention, in a first operating state.

FIG. 4 is a partial section through the pressblower injection blow molding device shown in FIG. 3, in a second operating state.

FIG. 5 is a partial section through the pressblower injection blow molding device shown in FIGS. 3 and 4, in a closed, third operating state.

FIG. 6 is a section through an injection/extrusion device in an open, first working position in accordance with an embodiment of the present invention.

FIG. 7 is a partial section through the injection/extrusion device shown in FIG. 6, in a second working position in accordance with an embodiment of the present invention.

FIG. 8 is a section through the injection/extrusion device shown in FIGS. 6 and 7, with a formed parison in a third working position in accordance with an embodiment of the present invention.

FIG. 9 is a section through the injection/extrusion device shown in FIGS. 6 through 8, with a closing blow molding die in a fourth working position in accordance with an embodiment of the present invention.

FIG. 10 is a section through the injection/extrusion device shown in FIGS. 6 through 9, with a closed blow molding die and a formed bellows in a fifth working position in accordance with an embodiment of the present invention.

### DETAILED DESCRIPTION

While the present invention is described with respect to a method and apparatus for a bellows with a fastening mechanism, the present invention may be adapted and utilized for other flexible sealing applications mating with a circumferential surface of a structural part, including such applications outside of the constant velocity joint art.

In the following detailed description, spatially orienting terms are used such as “left,” “right,” “vertical,” “horizontal,” and the like. It is to be understood that these terms are used for convenience of description of the components or embodiments by reference to the drawings. These terms do not necessarily describe the absolute location in space, such as left, right, upward, downward, etc., that any part must assume. Further, in the following description, various operating parameters and components are described for several constructed embodiments. These specific parameters and components are included as examples and are not meant to be limiting.

In the context of the present invention, the phrase “at least partially enclosed” means that at least subregions of the fastening mechanism come into contact with the plastic material. In this context, it is possible for only a subregion of the inside of the fastening mechanism oriented toward the collar region to come into contact with the plastic material. However, it is also possible for the edges of the fastening mechanism or also the outside of the fastening mechanism to at least partially come into contact with the plastic material, particularly toward the edges, and be enclosed by it.

In the context of the present invention, the phrase “integrally joined” means that the bellows and the fastening mechanism comprise a single unit so that the fastening mechanism is secured to the bellows in a preassembled fashion. However, when the bellows is not installed, the elasticity of the plastic material of which the bellows is manufactured permits the fastening mechanism to be detached from the bellows and placed back onto it through an exertion of force. In the context of the present invention, the phrase “integrally joined” does not specifically mean that the fastening mechanism is non-detachably fastened to the bellows, but this can in fact be the case. Further, the edges of the fastening mechanism at least partially rest against the collar region of the bellows. Correspondingly, the collar region of the bellows has two circumferential flanks advantageously extending continuously around it, particularly in the circumference direction of the bellows, against which the edges of the fastening mechanism rest. When the bellows according to the present invention is manufactured, the shrinkage of the plastic material after it cools lends the fastening mechanism a certain amount of play, which allows it to move in the resulting annular groove. Alternatively, however, it is also possible for the fastening mechanism to be not only integrally joined to the bellows, but integrally joined to it in a permanent fashion, i.e. an essentially non-detachable connection is achieved, in particular, by vulcanizing the fastening mechanism into the bellows, at least on the inside of the fastening mechanism oriented toward the collar region, but possibly also in the region of the two edges of the fastening mechanism. This can occur particularly through the use of primers, which can be attached to the fastening mechanism before or after it is inserted into the processing die. The primer here can be selected in accordance with the material used for the fastening mechanism and also in accordance with the plastic material used on the side of the bellows oriented toward the inside of the fastening mechanism. If need be, the fastening mechanism could then be detached from the bellows again, by intentionally partly destroying the collar region of the bellows. In the case of an integrally joined, permanent connection, it is not necessary for the edges of the fastening mechanism to at least partially rest against the collar region. An adjustment can then be eliminated by the flanks situated in the collar region of a bellows, which flanks can be situated on the linkage or shaft side and on the bellows side of an annular groove.

If the edges of the fastening mechanism are only partially enclosed by plastic material, then a closing tool to be used can be guided by the protruding profile of the fastening mechanism. In another embodiment form, it is also possible for the plastic material in the region of the edges of the fastening mechanism to protrude beyond the plane defined by the outside of the fastening mechanism. These protrusions can be considered circumferential annular beads, which likewise make it possible to guide a closing tool that is to be used. The subject of the present invention also includes an embodiment which plastic material is situated on the outside of the fastening mechanism toward its edges. A distinguishing feature of this embodiment is that at least one sufficiently wide region of the fastening mechanism remains free of plastic material to permit the engagement of the closing tool that is to be used.

The bellows can be manufactured of a thermoplastic elastomer material or an elastomer material. Advantages are provided by thermoplastic elastomer materials. These include materials known from the prior art that have two different polymer segments, namely a relatively rigid resin segment and an elastic soft segment. The individual polymer segments are comprised of longer chains of similar monomers. The resin segments hold the soft segments together by physical, network-like bonds. A known thermoplastic elastomer material for manufacturing bellows is the plastic material marketed under the brand name “Hytrel” by the DuPont Company.

In another aspect of the invention, the collar region of the bellows is at least partially manufactured of an elastomer material. In contrast with thermoplastic elastomer materials, an elastomer material has the advantage of having a reduced, so-called “cold flow” when situated underneath the fastening element. This “cold flow” is understood to be the phenomenon in which, when subjected to clamping stress, the plastic material in the collar regions “escapes” laterally from the fastening mechanism, as a result of which, the bellows can come loose during operation, particularly when under thermal stress. If at least the region of the collar situated underneath the fastening mechanism is manufactured of an elastomer material, then it is possible to reliably avoid the above-mentioned disadvantages. Other regions of the collar region can nevertheless be manufactured of a thermoplastic elastomer material. The same advantage can also be achieved if a layer of a thermoplastic elastomer material is placed underneath the elastomer material. Possible plastics or mixtures that can be used as the elastomer materials include, e.g. urethane rubber, e.g. thermoplastic polyurethane with polyester as a polyol component, polyester-based urethane/rubber mixtures, or polychloroprenes.

The collar region of the bellows is advantageously at least partially comprised of a layer of a thermoplastic elastomer material and a layer of an elastomer material. To a great extent, this avoids the known disadvantages of using thermoplastic elastomer materials in the clamping region of the collar. It is also possible for the layer, which is comprised of an elastomer material, to be integrally joined in a permanent fashion to the fastening mechanism.

In a further aspect of the method according to the invention, a first ring made of an elastomer material is also provided against the inside of the fastening mechanism in the first fixing point. In this case, the first ring and the fastening mechanism can be inserted into the first fixing point together or one after another. These two components can also be already attached to each other ahead of time, possibly also in a detachable fashion, for example by being vulcanized onto each other or through application of an adhesive. The insertion of the ring of elastomer material and the fastening mechanism into the first fixing point makes it possible to embody the collar region of a bellows so that it is substantially comprised of an elastomer material in the region beneath the fastening mechanism in order to prevent the “cold flow” phenomenon.

The processing die for manufacturing the bellows basically has two fixing points; the one fixing point essentially corresponds to the shaft collar region of the finished bellows and the other fixing point substantially corresponds to the linkage collar region of the finished bellows. The first fixing point can consequently correspond to either the shaft collar region or the linkage collar region of the finished bellows. In this case, it is particularly advantageous for the fixing point, which corresponds to the shaft collar region, to be comprised of one or several parts and, advantageously, to have three or possibly more jaws.

When manufacturing the bellows according to the invention by the method according to the invention, the processing die advantageously covers an open space at the fixing points. This open space is delimited on one side by the bellows flank of the annular groove formed in the collar region and is delimited on the opposite side by the bellows edge of the fastening mechanism. The fastening mechanism is thus inserted into the fixing points in such a way that on the respective bellows side, the profile of the respective fixing point of the processing die is defined so that the corresponding open space can be formed there, too.

An additional fastening mechanism can also be provided, whose outside, which is situated in the region of the part of the processing die opposite from that of the first fixing point, rests against a second fixing point. This makes it possible, in a single process step, to obtain bellows having a fastening mechanism that is situated in the collar regions at both the shaft end and the linkage end and is integrally joined to the bellows, possibly integrally joined to it in a permanent fashion. Further, a second ring of an elastomer material can also be placed against the inside of the additional fastening mechanism. In this way, both collar regions of a bellows can essentially be equipped with an elastomer material in the region beneath the fastening mechanism in order to prevent the occurrence of the “cold flow” phenomenon. According to a particularly advantageous embodiment of the method according to the invention, a fastening mechanism is inserted into both the first and second fixing points.

The method according to the invention can be carried out in the form of a pressblower injection blow molding process—for which corresponding devices can be used, for example from the company Ossberger GmbH & Co. in Weissenberg, Germany. The method can also be carried out with an injection/extrusion process, an injection molding process, an injection/pressing process, and/or an extrusion/blow molding process. The pressblower injection blow molding process and the injection/extrusion process are largely identical. Both are advantageous since, particularly with the extrusion/blow molding process, the difficulty is that the insertion of the fastening mechanism and possibly also the additional ring made of an elastomer material must be executed by stretching the extruded tube, which hangs from a nozzle, over them. Furthermore, the pressblower injection blow molding process or injection/extrusion process can produce precisely dimensioned bellows.

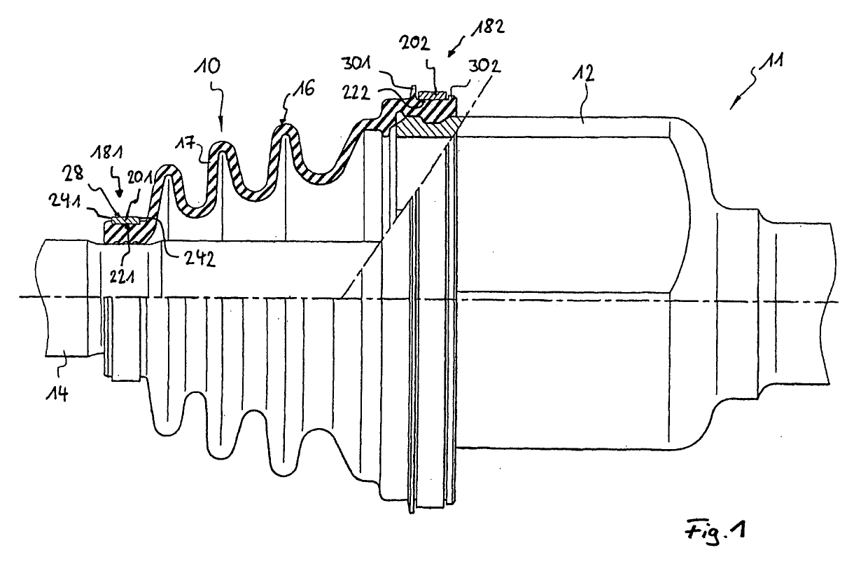

Referring now to the drawings wherein like reference numerals are used to identify identical components in the various views, FIG. 1 illustrates a partial section through a linkage component in a first embodiment in the form of a bellows. The linkage component is labeled as a whole with the reference numeral 11, including a bellows 10, a shaft 14, and a linkage casing 12. The interior of the linkage is not shown in detail. The bellows 10 has a number of folds 17 as well as a shaft collar region 181 and a linkage casing collar region 182. The collar region 182 is affixed to the shaft 14 by an annular fastening mechanism 201 in the form of a clamping strap. The collar region 182 is affixed to the linkage casing 12 by a fastening mechanism 202, likewise embodied in the form of a clamping strap.

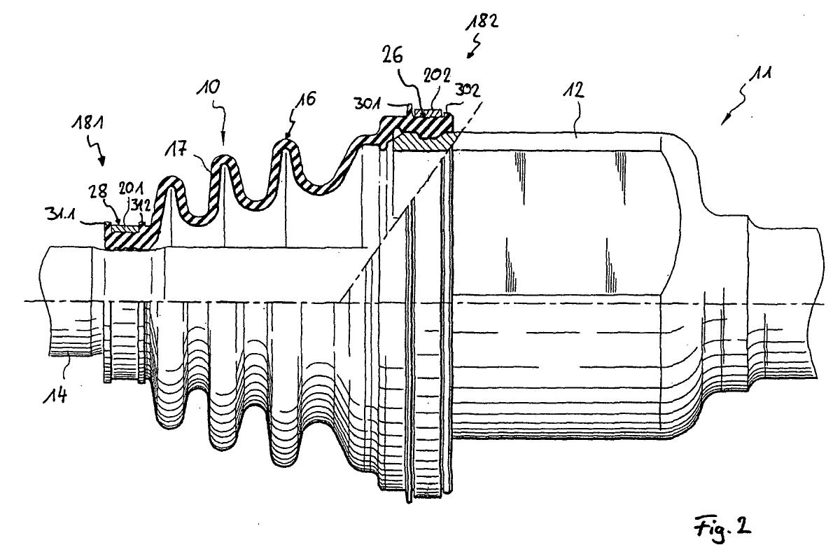

The fastening mechanism 201 and 202 is integrally joined to the corresponding collar region 181 and 182. The fastening mechanism 202 is, in particular, integrally joined in a permanent fashion by being vulcanized into place during the manufacture of the bellows 10. The insides 221 and 222 of the fastening mechanism 201 and 202 are oriented toward the bottom 26 (see FIG. 2) of an annular groove produced in the collar regions 181 and 182 during the manufacture of the bellows 10. The outsides 28 of the fastening mechanism 201 and 202 remain uncovered so that in this instance, a closing tool can engage the fastening mechanism 201 and 202 directly.

In the collar region 181, the edge 241 of the clamping strap 201 oriented away from the bellows and its edge 242 oriented toward the bellows region 16 are partially enclosed, for example halfway, by the plastic material of the bellows 10. As a result, the profile of the clamping strap 201 protrudes up from the plane formed by the plastic material of the bellows 10 so that it provides a guide for a flow tool engaging it.

The collar region 182 is embodied differently, such that the edges of the clamping mechanism 202 remains uncovered so that only the inside 222 of the fastening mechanism 202 is in direct contact with the plastic material of the collar region 182 and is integrally joined to it in a permanent fashion. On both the side of the collar region 182 oriented away from the bellows and the side of the collar region 182 oriented toward the bellows region 16, annular beads 301 and 302 are provided, which can extend continuously around the entire collar region 182. The annular bead 301 is embodied so that it protrudes beyond the plane formed by the outside of the fastening mechanism 202 so that here, too, a reliable guide is provided for the engagement of the closing tool (not shown).

FIG. 2 shows a second embodiment form of a bellows 10 attached to a linkage component 11. In contrast with the embodiment shown in FIG. 1, the collar region 181 is such that both the side of the collar region 181 oriented away from the bellows region 16 and the side of the collar region 181 oriented toward the bellows region 16 are provided with a respective annular bead 311 and 312, both of which protrude beyond the plane formed by the outside of the fastening mechanism 201. These annular beads 311 and 312 provide a guide for a closing tool that engages the clamping strap 201 in order to close it, thus permitting a secure and even closing of the clamping strap 201.

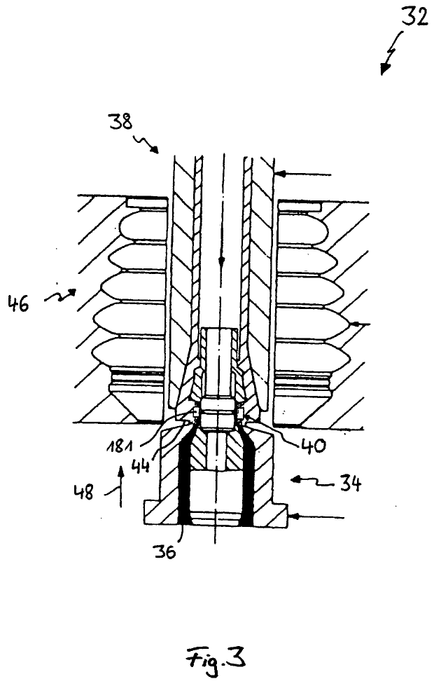

A method according to the invention will now be explained in conjunction with a pressblower injection blow molding process/injection-extrusion process according to FIGS. 3 through 5.

FIG. 3 shows a pressblower injection blow molding device labeled as a whole with the reference numeral 32, including a melt supply nozzle 34, an injection molding die 38 to form the shaft collar region 181, and a blow molding die 46 in an open position. The injection molding die 38 has a clamp 44, with usually three, but possibly also more, jaws that define a fixing point 40 for accommodating a fastening mechanism 201. The jaw surfaces here have a step-like outer contour, which on the one hand, makes it possible to accommodate the fastening mechanism 201 and on the other hand —as also shown in FIG. 1—makes it possible to produce a shaft collar region 181 in which the plane formed by the outside of the fastening mechanism 201 protrudes above the one formed by the previously molded plastic. The melt supply nozzle 34 supplies plastic material in the form of a melt 36 to the injection molding die 38 and fills the space at the fixing point 40 with the melt 36. Then, the injection molding die 38 is moved in the direction of the arrow 48.

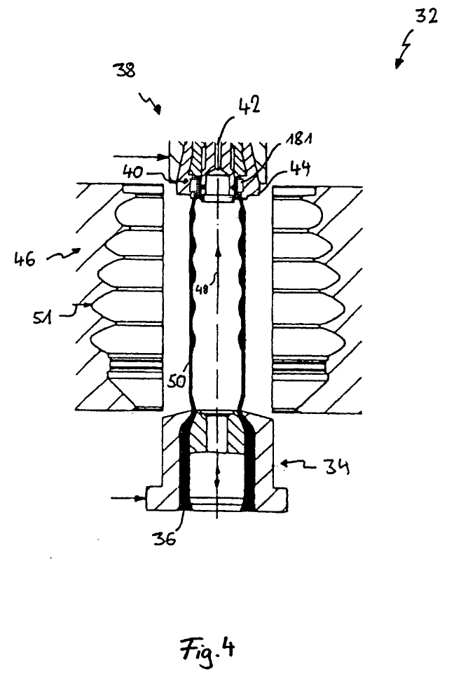

According to FIG. 4, the injection molding die 38 moves until it reaches an end position situated approximately above the blow molding die 46. At the same time as the retraction of the injection molding die 38, the melt 36 is formed into a parison 50 with a desired wall thickness distribution. In general, the wall thickness distribution can be electronically controlled by a program that functions to adjust the nozzle cone and the pressing of the melt 36 out of the reservoir of the melt supply nozzle 34. FIG. 4 also shows that the injection molding die 38 has a blowing mandrel 42 through which blowing air can be conveyed. After the formation of the parison 50 with the desired wall thickness distribution, the blow molding die 46 is closed in the direction of the arrow 51.

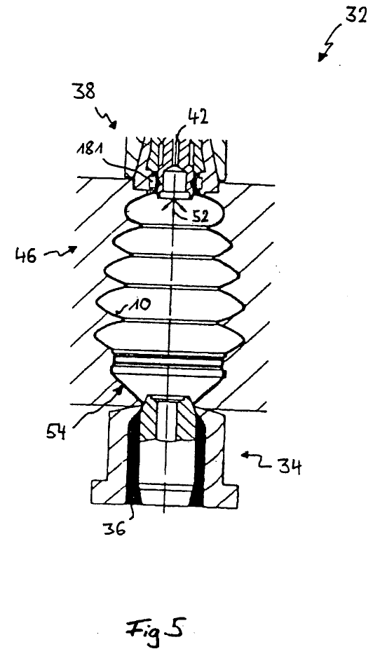

FIG. 5 shows a section through the pressblower injection blow molding device after the blow molding die 46 is closed and blowing air is being blown in according to the arrows 52 via the blowing mandrel 42 of the injection molding die 38. As a result, the parison 50 is blown out and comes to rest against the outer contour of the blow molding die 46 to form a bellows 10. In the region of the blow molding die 46 oriented toward the melt supply nozzle 34, a flash segment 54 is formed, which can be removed by a simple cutting procedure once the blow molding die 46 is opened.

The pressblower injection blow molding method shown in FIGS. 3 through 5 has thus produced a bellows 10, which has a fastening mechanism 201 situated in the shaft collar region 181 and corresponds to the embodiment form shown in FIG. 1.

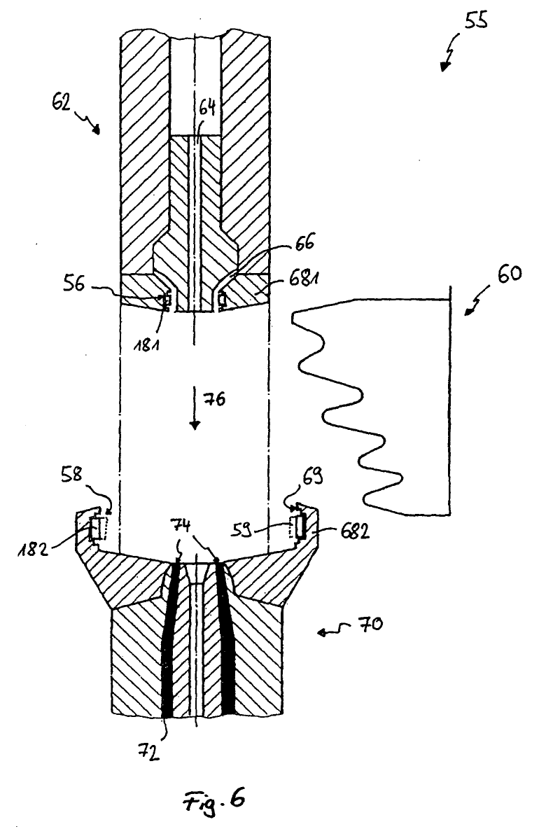

FIGS. 6 through 10 show the manufacture of a bellows with two fastening mechanisms 201, 202 by the injection/extrusion process.

FIG. 6 shows a section through an injection/extrusion device 55, including a blow molding die 60 (only shown schematically), an injection molding die 62, and, situated at the opposite end from this, a melt supply nozzle 70. The injection molding die 62 has a blowing mandrel 64 and one or more jaws 681. The jaws 681 and the blowing mandrel 64 define a fixing point 56. The jaws 681 have a step-like outer contour for accommodating an annular fastening mechanism 201, e.g. a clamping strap or compression ring. This makes it possible to place the fastening mechanism 201 in the shaft collar region 181 of a bellows 10, as is also shown in FIG. 1.

The other part of the injection/extrusion device 55 situated opposite the injection molding die 62, namely the melt supply nozzle 70, has an annular nozzle 74 via which melted plastic material 72 can be supplied. In addition, the melt supply nozzle 70 has one or more jaws 682, the insides of which have an outer contour 69 that is embodied as step-like in the same way as the upper jaws 681. The fixing point 58 formed by the outer contour 69 of the jaws 682 serves to position another fastening mechanism 202, namely a clamping strap. FIG. 2 also shows that immediately adjacent to and resting against the clamping strap 202, an elastomer ring 59 can be provided, which can be comprised, for example, of a urethane rubber. This elastomer ring 59 can be mounted to the clamping strap 202 ahead of time, e.g. by an adhesive, and inserted along with it into the fixing point 58 of the injection/extrusion device 55. After the insertion of the clamping straps 201 and 202 and possibly a forming ring 59, which can also be situated adjacent to the clamping strap 201 when provided with other dimensions, the injection molding die 62 travels toward the melt supply nozzle 70 in the direction of the arrow 76.

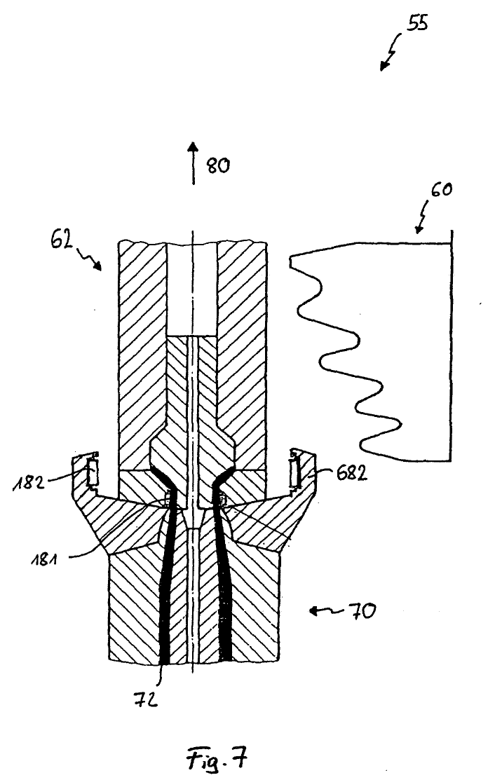

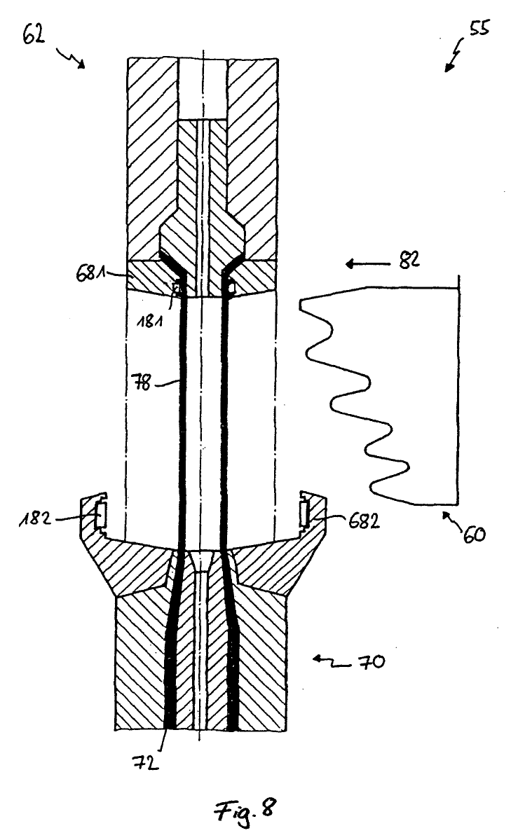

FIG. 7 shows the injection/extrusion device 55 in a second working position after the movement of the injection molding die 62 toward the melt supply nozzle 70. Melt 72 has now been injected into the open-space 66 in the injection molding die 62, thus integrally joining the fastening mechanism 201 to the plastic material. Then, the injection molding die 62 is moved in the direction of the arrow 80 in order to form a parison 78 (see FIG. 8).

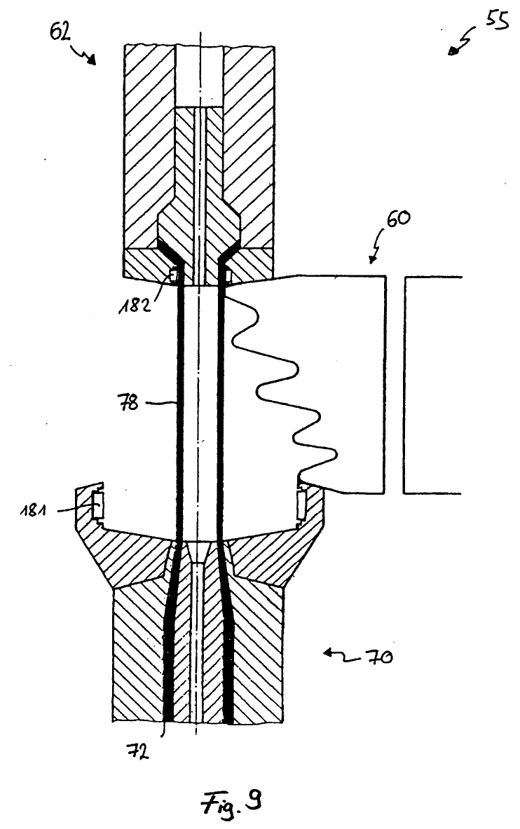

FIG. 8 shows a third working position of the injection/extrusion device 55, with the parison 78 stretched between the injection molding die 62 and the melt supply nozzle 70. The injection/extrusion device 55 is then closed with a movement of the blow molding die 60 in the direction of the arrow 82. This is shown on at least one side in FIG. 9.

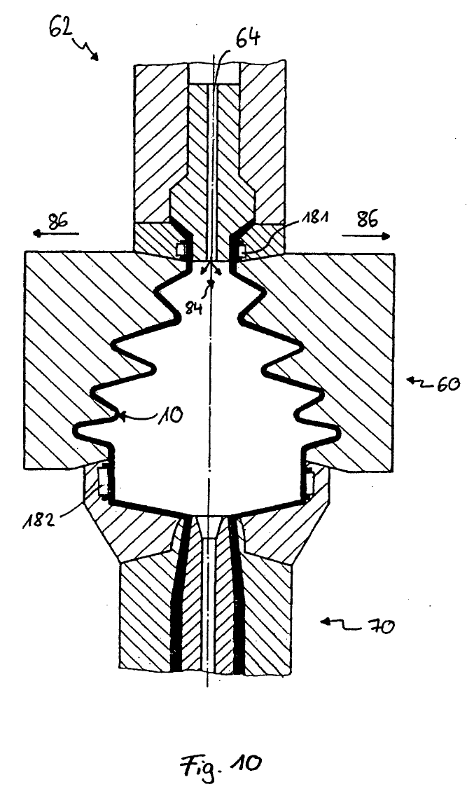

FIG. 10 is a section through the injection/extrusion device 55 in the closed position in which blowing air is blown via the blowing mandrel 64 in the direction of the arrows 84 into the interior of the parison 78 in order to form a bellows 10 defined by the outer contour of the blow molding die 60. As a result, the plastic material in the collar region 182 of the bellows 10 oriented toward the linkage part comes to rest directly against the clamping strap 202 to form an integral connection with it. Then, the blow molding die 60 can be opened in the direction of the arrows 86 and the finished bellows 10 can be removed. Any protruding flash segments or bases of the untrimmed bellows 10 are cut away. Like the pressblower injection blow molding process shown in FIGS. 3 through 5, the pulling of the parison 78 with a specifically adjusted wall thickness distribution can be achieved by an electronic program control.

With the method shown in FIGS. 3 through 10, in order to produce an integral, permanent connection, primers can be used, which are, in particular, attached to the inside of the fastening mechanism. If no primers are used, then the fastening mechanism can move in the resulting annular groove, but are nevertheless held securely in place.

The present invention consequently creates a bellows and a method for manufacturing bellows, which, through preinstallation of clamping straps, onto at least one collar region, permit a simpler installation, particularly in the case of linkage components. A secure and evenly sealed closing of the clamping straps is also assured through the engagement of a closing tool.

While the inventive bellows and method have been described in connection with one or more embodiments, the disclosure is not meant to be limiting. Rather, the invention covers all alternatives, modifications and equivalents within the spirit and scope of the appended claims.

1. A bellows for a linkage component comprising:
a bellows region;
a shaft collar region;
a linkage collar region; and
an annular fastening mechanism at the shaft collar or linkage collar region, which attaches the shaft or linkage collar region of the bellows to a shaft or linkage casing, respectively,
wherein the fastening mechanism is integrally joined to the shaft collar or linkage collar region by inserting the fastening mechanism into a processing die while molding the bellows to at least partially enclose the fastening mechanism by plastic material, and
wherein an outer surface of the fastening mechanism oriented away from the respective shaft collar or linkage collar region is adapted to engage a fastening tool.

2. A bellows according to claim 1, wherein the outer surface of the fastening mechanism comprises a metallic material.

3. A bellows according to claim 1, wherein side edges of the fastening mechanism at least partial contact the respective shaft collar or linkage collar region.

4. A bellows according to claim 1, wherein the fastening mechanism is a clamping strap.

5. A bellows according to claim 1, wherein the bellows is manufactured from a thermoplastic elastomer material or an elastomer material.

6. A bellows according to claim 1, wherein the shaft collar or linkage collar region at least partially comprises an elastomer material.

7. A bellows according to claim 1, wherein the shaft collar or linkage collar region of the bellows at least partially comprises a layer of a thermoplastic elastomer material and a layer of an elastomer material.

8. A bellows for a linkage component comprising:
a bellows region;
a shaft collar region;
a linkage collar region; and
an annular fastening mechanism at each of the shaft collar and linkage collar regions, which attaches the shaft collar and linkage collar regions of the bellows to a shaft and linkage casing, respectively,
wherein each fastening mechanism is integrally joined to the shaft collar and linkage collar region by inserting the respective fastening mechanism into a processing die while molding the bellows to at least partially enclose the fastening mechanism by plastic material, and
wherein an outer surface of each fastening mechanism oriented away from the respective shaft collar and linkage collar region is adapted to engage a fastening tool.

9. A bellows according to claim 8, wherein each fastening mechanism is a metal clamping strap, and wherein side edges of each fastening mechanism at least partial contact the respective shaft collar and linkage collar regions.

10. A method for manufacturing a bellows having a bellows region, a shaft collar region, and an integrally joined fastening mechanism at the shaft collar or linkage collar regions, comprising:
in a region of a first fixing point of a processing die, placing a fastening mechanism with at least part of its outer surface resting directly against the first fixing point; and
thereafter, forming the bellows out of a plastic material such that the fastening mechanism contacts the plastic material and is at least partially enclosed by it.

11. A method according to claim 10, comprising placing a first ring of an elastomer material against an inside surface of the fastening mechanism in the first fixing point.

12. A method according to claim 10, comprising, prior to forming the bellows, in a region of a second fixing point of a processing die opposite the first fixing point, placing a second fastening mechanism with at least part of its outer surface resting directly against the second fixing point.

13. A method according to claim 12, comprising placing a second ring of an elastomer material against an inside surface of the second fastening mechanism in the second fixing point.

14. A method according to claim 10 wherein the step of forming is executed in the form of a pressblower injection blow molding process, an injection/extrusion process, an injection molding process, an injection/pressing process, or an extrusion/blow molding process.

15. A method according to claim 10, comprising adding a primer to at least an inside surface of the fastening mechanism prior to forming the bellows.

16. A method according to claim 12, comprising adding a primer to at least an inside surface of the first or second fastening mechanism prior to forming the bellows.

17. A method for manufacturing a bellows having a bellows region, a shaft collar region, and an integrally joined fastening mechanism at the shaft collar and linkage collar regions, comprising:
in a region of a first fixing point of a processing die, placing a first fastening mechanism in the form of a metal clamping band with at least part of its outer surface resting directly against the first fixing point;
in a region of a second fixing point of a processing die opposite the first fixing point, placing a second fastening mechanism in the form of a metal clamping band with at least part of its outer surface resting directly against the second fixing point;
adding a primer to at least an inside surface of the first or second fastening mechanism; and
thereafter, forming the bellows out of a thermoplastic elastomer material or an elastomer material such that each fastening mechanism contacts the material and is at least partially enclosed by it.

18. A method according to claim 17, comprising, prior to forming the bellows, placing a ring of an elastomer material against an inside surface of the first or second fastening mechanism.

19. A method according to claim 17 wherein the step of forming is executed in the form of a pressblower injection blow molding process, an injection/extrusion process, an injection molding process, an injection/pressing process, or an extrusion/blow molding process.
